(19) United States
(12) Patent Application Publication
(10) Pub. No.: US 2006/0151378 A1
(43) Pub. Date: Jul. 13, 2006

(54) Fuel filter assembly for fuel delivery module

(76) Inventors: Brandon John Goll, Orion, MI (US); John Patrick Wattai, Rochester Hills, MI (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/330,419

(22) Filed: Jan. 10, 2006

Related U.S. Application Data
(60) Provisional application No. 60/642,961, filed on Jan. 11, 2005.

(51) Int. Cl. B01D 35/30

(52) U.S. Cl. 210/416.4; 210/232

(57) ABSTRACT

A fuel filter assembly 10 is provided for a fuel delivery module of a vehicle. The fuel filter assembly includes a metal housing 12 having a closed end 13 and an open end 11. A filter cartridge assembly 14 is received in the housing and includes a filter 38 having first and second ends. A first end cap 34 is coupled to the first end and a second end cap 36 is coupled to the second end. An electrically conductive plastic cover 16 closes the open end 11 of the housing. The cover includes an integral inlet connection 26 and an integral outlet connection 28. The filter assembly 10 is constructed and arranged such that fuel may enter the inlet connection, be filtered by the filter, and exit via the outlet connection. Each of the housing, filter cartridge assembly and cover defines a bore there through so as to define a pump bore 18 through the fuel filter assembly. The pump bore is constructed and arranged to receive a fuel pump of a fuel delivery module.

This application is based on U.S. application Ser. No. 60/642,961, filed on Jan. 11, 2005 and claims the benefit thereof for priority purposes.

### FIELD OF THE INVENTION

This invention relates to in-tank vehicle fuel pump sending units and, more particularly, to a fuel filter assembly for a fuel delivery module for a fuel system of a vehicle.

### BACKGROUND OF THE INVENTION

Fuel filter assemblies are typically located in a fuel delivery module reservoir. There must be a path of electrostatic discharge throughout the filter assembly. Conventional fuel filter assemblies use metallic housings and covers to achieve electrostatic discharge.

The conventional fuel filter assemblies also include many other separate components such as a pressure regulator assembly (relief valve) elsewhere in fuel delivery module reservoir; a regulator (relief valve) positioned such that it is on a filtered side of the fuel to minimize contamination of the regulator seal; separate connector components within the filter assembly used for attachment of inlet and outlet tubes; and additional clamps required to hold hoses on non-barbed metal filter inlet and outlet connections. These separate components increase cost and assembly time.

Thus, there is a need to provide an improved fuel filter assembly that enables electrostatic discharge throughout the assembly and integrates components into a one-piece cover.

### SUMMARY OF THE INVENTION

An object of the invention is to fulfill the need referred to above. In accordance with the principles of the present invention, this objective is achieved by providing a fuel filter assembly for a fuel delivery module of a vehicle. The fuel filter assembly includes a metal housing having a closed end and an open end. A filter cartridge assembly is received in the housing and includes a filter having first and second ends. A first end cap is coupled to the first end and a second end cap is coupled to the second end. An electrically conductive plastic cover closes the open end of the housing. The cover includes an integral inlet connection and an integral outlet connection. The filter assembly is constructed and arranged such that fuel may enter the inlet connection, be filtered by the filter, and exit via the outlet connection. Each of the housing, filter cartridge assembly and cover defines a bore there through so as to define a pump bore through the fuel filter assembly. The pump bore is constructed and arranged to receive a fuel pump of a fuel delivery module.

In accordance with another aspect of the invention, a method of providing a fuel filter assembly for a fuel delivery module of a vehicle includes the provision of a metal housing having a closed end and an open end. A filter cartridge assembly is placed through the open end and into the housing. The filter cartridge assembly includes a filter having first and second ends, with a first end cap coupled to the first end and a second end cap coupled to the second end. An electrically conductive plastic cover is provided and includes an integral inlet connection and an integral outlet connection. The open end of the housing is closed with the cover such that fuel may enter the inlet connection, be filtered by the filter, and exit via the outlet connection.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is an exploded view of a fuel filter assembly provided in accordance with the principles of the present invention.

FIG. 2 is a sectional view showing the connection of the cover with the housing at an inlet of the assembly of FIG. 1.

FIG. 3 is a sectional view showing a blade seal to seal between clean and dirty fuels at a portion near the top of the assembly of FIG. 1.

FIG. 4 is a sectional view showing a blade seal to seal between clean and dirty fuels at a portion near the bottom of the assembly of FIG. 1.

FIG. 5 is a view of a top end cap of the filter cartridge assembly of the assembly of FIG. 1, showing flow channels therein.

FIG. 6 is an isometric view of the filter assembly provided in accordance with the principles of the present invention.

FIG. 7 is a sectional view of the filter assembly of FIG. 6.

FIG. 8 is an isometric view of a filter assembly provided in accordance with a second embodiment of the invention.

### DETAILED DESCRIPTION OF THE EXEMPLARY EMBODIMENTS

A fuel filter assembly is shown generally indicated at 10 in FIGS. 1 and 6 in accordance with the principles of the present invention. The assembly 10 is constructed and arranged to be located in a conventional fuel delivery module reservoir (not shown). The filter assembly 10 has a geometry exhibiting a hollow circular area cross-section to allow placement surrounding a fuel pump (not shown) within the reservoir. Thus, as shown in FIG. 6, the assembly 10 includes a generally cylindrical can or housing 12. The housing 12 receives a donut-shaped filter cartridge assembly 14 (FIG. 1). An open end 11 of the housing 12 is closed by a cover 16. The other end of the housing 12 is a closed end 13. The housing 12, filter cartridge assembly 14, and cover 16 each have a bore there-through defining a pump bore 18 of the assembly 10, so that the fuel pump can be inserted into the central bore 18.

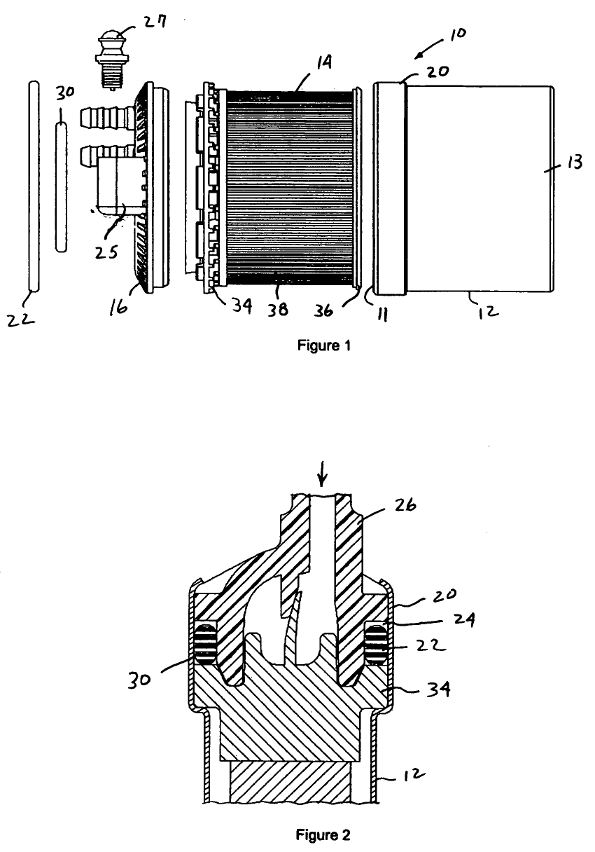

With reference to FIGS. 1 and 2, the housing 12 includes a cover receiving portion 20 that receives a portion of the cover 16. An outer O-ring 22 is provided in groove 24, defined by the cover 16 and a portion of an end cap 34, to provide a seal between the outer diameter of the cover 16 and the inner diameter of the housing 12. An inner O-ring 30 provides a seal between the cover 16 and housing 12 at an inner portion thereof (e.g., near bore 18).

As best shown in FIG. 6, the cover is preferably molded from conventional electrically conductive plastic to include an integral fuel inlet connection 26 or port near an outer periphery of the cover 16 and an integral fuel outlet connection 28 or port near an inner periphery of the cover 16. Each connection 26 and 28 includes a barbed fitting 29 constructed and arranged to receive a tube (not shown) in the conventional manner. The cover 16 advantageously includes an integrated valve mounting feature 25 for carrying a separate pressure relief valve 27 that is fluidly coupled with the interior of the assembly 10. Thus, when pressure inside the assembly 10 becomes too great, the relief valve 27 will open to expel fuel and thus, reduce the pressure of fuel in the assembly 10. In the illustrated embodiment, the valve mounting feature 25 is in the form of a hollow tube that receives the valve 27 therein.

The connections 26, 28, and mounting feature 25, integral with the conductive plastic cover 16 eliminate the need for additional components and assembly operations including: 1) separate pressure regulator assembly (relief valve) elsewhere in fuel delivery module reservoir, 2) a regulator (relief valve) positioned such that it is on the filtered side of the fuel to minimize contamination of the regulator seal, 3) separate connector components within the filter assembly used for attachment of inlet and outlet tubes, and 4) additional clamps required to hold hoses on non-barbed metal filter inlet and outlet connections.

As shown in FIG. 1, the filter assembly includes preferably conductive plastic end caps 34, 36 at each end thereof. The end caps can be heat welded to the filter body 38. In the broadest aspect of the invention, the end caps 34, and 36 need not be conductive.

To maintain a path of electrostatic discharge throughout the filter assembly 10, the housing 12 is manufactured with a conductive metal and the cover 16 is manufactured from a conductive plastic. In addition, as noted above, the filter cartridge assembly, within the assembly 10, preferably utilizes the conductive plastic end caps 34 and 36.

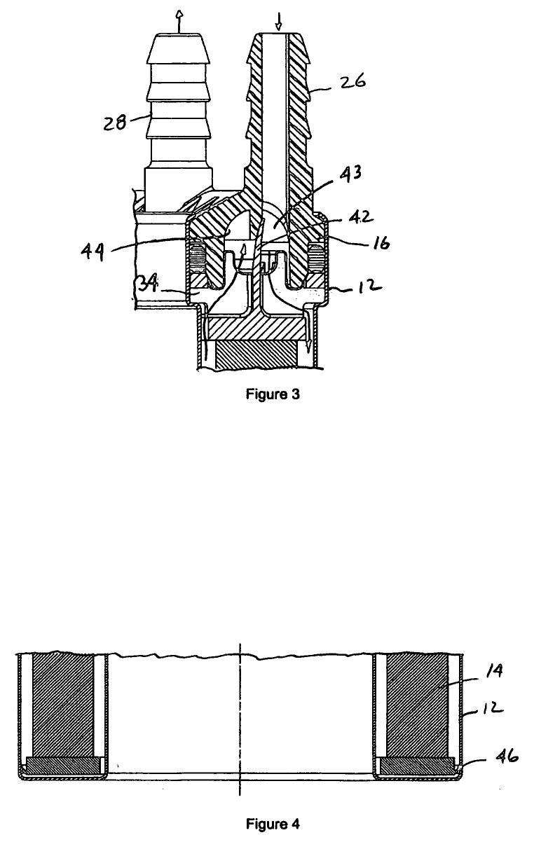

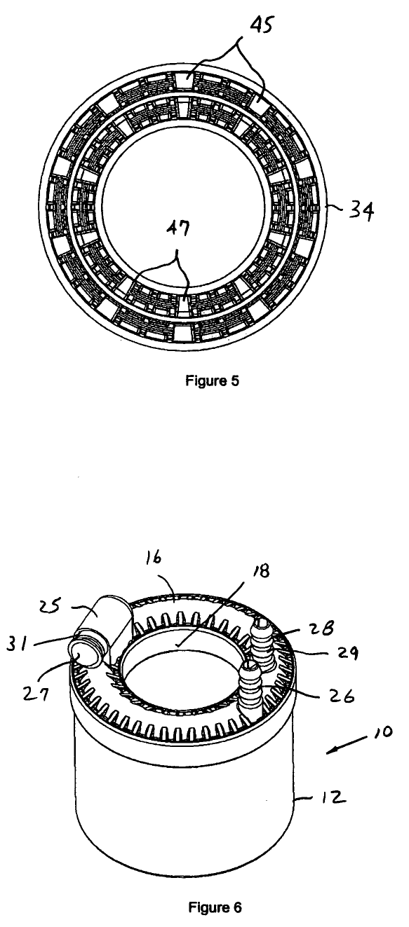

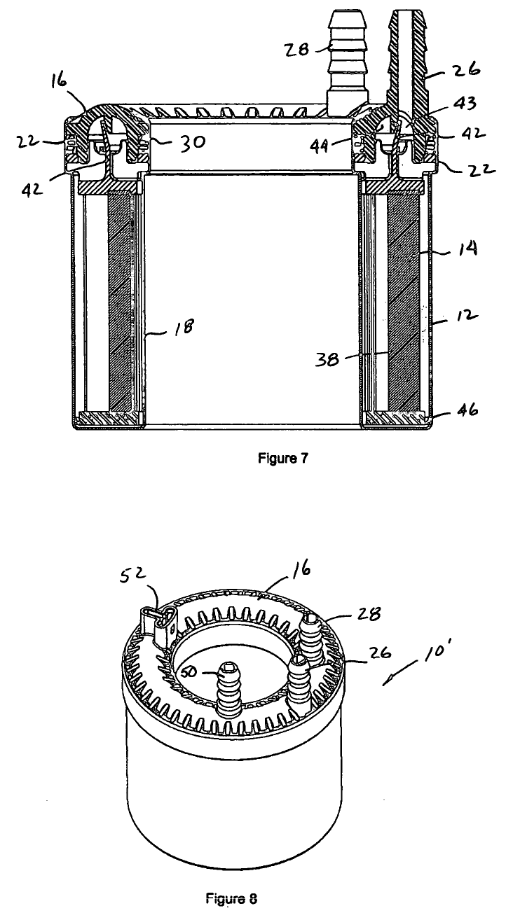

With reference to FIG. 7, near the top of the filter cartridge assembly, an annular blade seal 42 is provided to prevent dirty fuel that enters inlet chamber 43 via port 26 to initially bypass the filter 38, be filtered by the filter 38, enter chamber 44, and exit the outlet port 28. Thus, the blade seal 42 ensures substantially all dirty fuel is filtered by filter 38 prior to exiting the assembly 10. An enlarged view of a portion of the blade seal is shown in FIG. 3. With reference to FIG. 4, a second annular blade seal 46 is provided at the bottom of the filter cartridge assembly 14 to separate dirty fuel from clean fuel prior to the dirty fuel being filtered. O-rings or other conventional seals can also be used to perform these functions. Thus, with reference to FIG. 7, fuel needing to be filtered (dirty fuel) enters the inlet port 26 and since the fuel is blocked from the clean fuel via seals 42 and 46, the fuel passes through the filter 38 and then exits via outlet port 28. FIG. 5 shows inlet flow channels 45 and outlet flow channels 47 in end cap 34.

The filter assembly 10 offers the following advantages:
1. The metal housing 12 requires less material thickness than plastics in order to meet strength requirements of fuel filter assembly, maximizing fuel volume in reservoir and area available for filter media.
2. Assembly methods and tooling are simplified with use of the plastic cover 16. Conventional filter assemblies exhibiting the hollow circular cross section have used metal covers requiring laser welding and brazing operations for cover and inlet/outlet connections or have used plastic covers with plastic housings requiring plastic laser welding. The metal housing 12 is secured to the plastic cover 16 using a means such as crimping the housing over the cover on both the inside diameter and outside diameter.
3. The electrostatic discharge (ESD) path in the fluid flowing areas is guaranteed through the use of a metal housing 12 in combination with the preferably conductive filter end caps 34, 36 and a conductive filter cover 16. The discharge to ground can be achieved through the metal housing or the filter cover. It is intended that the connections 26 and 28 connect to conductive tubes to maintain the ESD path in the fluid flow.
4. The seal of the filter 38 from non-filtered side to filtered side is achieved via lower end cap sealing to metal housing via a radial lip or blade seal 46 and upper end cap sealing to the filter cover via a radial lip or blade seal 42. These sealing techniques eliminate the need for internal O-rings and/or plastisol glue.

FIG. 8 shows another embodiment of a filter assembly 10′. Instead of clean fuel going directly to an integrated regular as in FIG. 6, another outlet 50 is provided which can be connected by tubing to a separate regulator (not shown). The separate regulator can be connected to the cover 16 via a clip 52.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A fuel filter assembly for a fuel delivery module of a vehicle, the fuel filter assembly comprising:
a metal housing having a closed end and an open end,
a filter cartridge assembly received in the housing, the filter cartridge assembly including a filter having first and second ends, a first end cap being coupled to the first end and a second end cap being coupled to the second end, and
a conductive plastic cover closing the open end of the housing, the cover including an integral inlet connection and an integral outlet connection, the filter assembly being constructed and arranged such that fuel may enter the inlet connection, be filtered by the filter, and exit via the outlet connection,
wherein each of the housing, filter cartridge assembly and cover defines a bore there through so as to define a pump bore through the fuel filter assembly, the pump bore being constructed and arranged to receive a fuel pump of a fuel delivery module.

2. The fuel filter assembly of claim 1, wherein the cover further includes an integral pressure relief valve mounting feature.

3. The fuel filter assembly of claim 2, in combination with a pressure relief valve carried by the valve mounting feature and fluidly coupled with the filter assembly to relieve pressure in the filter assembly.

4. The fuel filter assembly of claim 3, wherein the valve mounting feature is in the form of a hollow tube, with at least a portion of the pressure relief valve being disposed in the tube.

5. The fuel filter assembly of claim 1, further comprising seal structure constructed and arranged to separate dirty fuel from clean fuel in the filter assembly.

6. The fuel filter assembly of claim 5, wherein the seal structure includes an annular seal near a top portion of the filter cartridge assembly constructed and arranged to separate dirty fuel that enters the fuel filter assembly via the inlet connection from filtered fuel in the fuel filter assembly prior to the dirty fuel being filtered by the filter cartridge assembly.

7. The fuel filter assembly of claim 5, wherein the seal structure includes a seal near a bottom of the filter cartridge assembly.

8. The fuel filter assembly of claim 5, wherein the seal structure includes a first annular blade seal near a top portion of the filter cartridge assembly constructed and arranged to separate dirty fuel that enters the fuel filter assembly via the inlet connection from filtered fuel in the fuel filter assembly prior to the dirty fuel being filtered by the filter cartridge assembly, and a second annular blade seal near a bottom of the filter cartridge assembly.

9. The fuel filter assembly of claim 8, wherein each of the seals is a blade seal.

10. The fuel filter assembly of claim 1, wherein each of the inlet and outlet connections includes a barbed fitting constructed and arranged to permit a tube to be attached thereto.

11. The fuel filter assembly of claim 1, wherein the end caps are composed of electrically conductive plastic.

12. The fuel filter assembly of claim 2, wherein the a second integral outlet connection is provided in the cover and wherein valve mounting feature is in the form of a clip constructed and arranged to mount a separate regulator that receives fuel via the second integral outlet connection.

13. A fuel filter assembly for a fuel delivery module of a vehicle, the fuel filter assembly comprising:
a metal housing having a closed end and an open end,
means for filtering fuel received in the housing, the means for filtering having first and second ends, a first end cap being coupled to the first end and a second end cap being coupled to the second end, and
means for closing the open end of the housing, the means for closing including an integral inlet connection and an integral outlet connection, the filter assembly being constructed and arranged such that fuel may enter the inlet connection, be filtered by the means for filtering, and exit via the outlet connection,
wherein each of the housing, means for filtering, and the means for covering defines a bore there-through so as to define a pump bore through the fuel filter assembly, the pump bore being constructed and arranged to receive a fuel pump of a fuel delivery module.

14. The fuel filter assembly of claim 13, wherein the means for closing further includes an integral pressure relief valve mounting feature.

15. The fuel filter assembly of claim 14, in combination with a pressure relief valve carried by the valve mounting feature and fluidly coupled with the means for filtering to relieve pressure in the filter assembly.

16. The fuel filter assembly of claim 15, wherein the valve mounting feature is in the form of a hollow tube, with at least a portion of the pressure relief valve being disposed in the tube.

17. The fuel filter assembly of claim 13, further comprising seal structure constructed and arranged to separate dirty fuel from clean fuel in the filter assembly.

18. The fuel filter assembly of claim 17, wherein the seal structure includes an annular seal near a top portion of the means for filtering constructed and arranged to separate dirty fuel that enters the fuel filter assembly via the inlet connection from filtered fuel in the means for filtering prior to the dirty fuel being filtered by the means for filtering.

19. The fuel filter assembly of claim 17, wherein the seal structure includes a seal near a bottom of the means for filtering.

20. The fuel filter assembly of claim 17, wherein the seal structure includes a first annular blade seal near a top portion of the means for filtering constructed and arranged to separate dirty fuel that enters the means for filtering via the inlet port from filtered fuel in the means for filtering prior to the dirty fuel being filtered by the means for filtering, and a second annular blade seal near a bottom of the means for filtering.

21. The fuel filter assembly of claim 20, wherein each of the seals is a blade seal.

22. The fuel filter assembly of claim 13, wherein the inlet and outlet connections each include a barbed fitting constructed and arranged to permit tubes to be attached thereto.

23. The fuel filter assembly of claim 13, wherein the end caps are composed of electrically conductive plastic.

24. The fuel filter assembly of claim 14, wherein a second integral outlet connection is provided on the means for closing and wherein valve mounting feature is in the form of a clip constructed and arranged to mount a separate regulator that receives fuel via the second integral outlet connection.

25. A method of providing a fuel filter assembly for a fuel delivery module of a vehicle, the method including:
providing a metal housing having a closed end and an open end,
placing a filter cartridge assembly through the open end and into the housing, the filter assembly cartridge including a filter having first and second ends, with a first end cap coupled to the first end and a second end cap coupled to the second end,
providing an electrically conductive plastic cover including an integral inlet connection and an integral outlet connection, and
closing the open end of the housing with the cover such that fuel may enter the inlet connection, be filtered by the filter, and exit via the outlet connection.

26. The method of claim 25, further comprising:
ensuring that each of the housing, filter cartridge assembly and cover defines a bore there-through so as to define a pump bore through the fuel filter assembly, the pump bore being constructed and arranged to receive a fuel pump of a fuel delivery module.

27. The method of claim 25, wherein the step of providing a cover further includes:
providing a pressure relief valve mounting feature integral with the cover.

28. The method of claim 27, further comprising:
mounting a pressure relief valve with respect to the valve mounting feature and the filter assembly so as to relieve pressure in the filter assembly.

29. The method of claim 25, wherein the first and second end caps are composed of electrically conductive plastic.
